(19) United States
(12) Patent Application Publication
(10) Pub. No.: US 2011/0142278 A1
(43) Pub. Date: Jun. 16, 2011

(54) Visual-Based Contactless Communication Device and Method Thereof

(75) Inventors: Yun-Ter Su, Taipei City (TW); Chi-Pin Chen, Hsinchu City (TW); Ta-Chih Hung, Zhubei City (TW); Sz-Yun Liu, Daxi Township (TW); Bor-Tung Jiang, Hsinchu City (TW)

(73) Assignee: INDUSTRIAL TECHNOLOGY RESEARCH INSTITUTE, Chutung (TW)

(21) Appl. No.: 12/772,705

(22) Filed: May 3, 2010

(30) Foreign Application Priority Data
Dec. 11, 2009 (TW) 098142437

(51) Int. Cl. G06K 9/00

(52) U.S. Cl. 382/100

(57) ABSTRACT

A visual-based contactless communication device adapted to communicate with one or more visual-based contactless devices includes a photographic device for photographing image data displayed by one or more visual-based contactless communication devices; a center control device for identifying predetermined information in the image data, producing response information according to the predetermined information and generating effective image data identifiable by one or more visual-based contactless communication devices according to the response information or specified information; and a display device for displaying the effective image data to be photographed by one or more visual-based contactless communication devices; wherein when two visual-based contactless communication devices communicate with each other, one displays the effective image data with the response information after identifying the predetermined information, and the other proceeds with subsequent communication only after identifying the effective image with the response information and confirming that the response information is recognized.

### CROSS REFERENCE TO RELATED APPLICATION

This application claims priority of Taiwan Patent Application No. 98142437, filed on Dec. 11, 2009, the entirety of which is incorporated by reference herein.

### BACKGROUND OF THE INVENTION

1. Field of the Invention

The present invention relates to a contactless communication device and method thereof and in particular relates to a visual-based contactless communication device and method thereof.

2. Description of the Related Art

There are two types of communication methods between general electronic devices. One is a contact method and the other is a contactless method. Contact communications, is when two or more devices physically, directly or indirectly, are in contact with one another. For contact communications between devices, conventionally, a fixed location for contacting at a specific time is necessary for each electronic device. Alternately, contactless communications is when two or more devices are not physically in contact with one another. Examples of contactless communication methods include wireless communications, or optical communications methods. The former may be a blue-tooth or a wireless communications method, and the latter may be an infrared communications method.

Conventional contactless communication signals such as electromagnetic waves may be harmful for human beings or may interfere with other communication signals. Additionally, electromagnetic waves may interfere with subsistence equipment or sophisticated instruments in hospitals, airplane equipment and semiconductor fabrication machinery. Meanwhile, signals of infrared transmission devices such as remote controllers may not interfere with other communication signals and cause electromagnetic interference. However, infrared transmission signals may co-interfere with one another, resulting in communication error. Also, infrared transmission signals are limited by distance, speed and dead corners.

Thus, a visual-based contactless communication device and method thereof that mitigates co-interference with other contactless communication devices is required.

### BRIEF SUMMARY OF INVENTION

A detailed description is given in the following embodiments with reference to the accompanying drawings.

In one embodiment, the present invention provides a visual-based contactless communication device adapted to communicate with one or more visual-based contactless devices. The visual-based contactless communication device comprises: a photographic device for photographing image data displayed by one or more visual-based contactless communication devices; a center control device for identifying predetermined information in the image data, producing response information according to the predetermined information and generating effective image data being identifiable by one or more visual-based contactless communication devices according to the response information or specified information; and a display device for displaying the effective image data to be photographed by one or more visual-based contactless communication devices. When two visual-based contactless communication devices communicate with each other, one displays the effective image data with the response information after identifying the predetermined information, the other proceeds with subsequent communication only after identifying the effective image data with the response information and confirming that the response information is recognized.

In another embodiment, the present invention provides a visual-based contactless communication method adapted to communicate with one or more visual-based contactless devices. The visual-based contactless communication method comprises: photographing image data displayed by one or more visual-based contactless communication devices by a photographic device in a visual-based contactless communication device; identifying predetermined information in the image data, producing response information according to the predetermined information and generating effective image data being identifiable by one or more visual-based contactless communication devices according to the response information or specified information by a center control device in the visual-based contactless communication device; and displaying the effective image data to be photographed by one or more visual-based contactless communication devices by a display device in the visual-based contactless communication device. When two visual-based contactless communication devices communicate with each other, one displays the effective image data with the response information after identifying the predetermined information, the other proceeds with subsequent communication only after identifying the effective image data with the response information and confirming that the response information is recognized.

### BRIEF DESCRIPTION OF DRAWINGS

The present invention can be more fully understood by reading the subsequent detailed description and examples with references made to the accompanying drawings, wherein:

FIG. 1 is a diagram showing a visual-based contactless communication device of the invention:

FIG. 2 is a flow chart illustrating a visual-based contactless communication method according to the embodiment of the invention;

FIG. 3 is a diagram showing a bi-directional communication embodiment of visual-based contactless communication devices of the invention; and

FIG. 4 is a flow chart illustrating bi-directional communication according to the embodiment of FIG. 3 of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

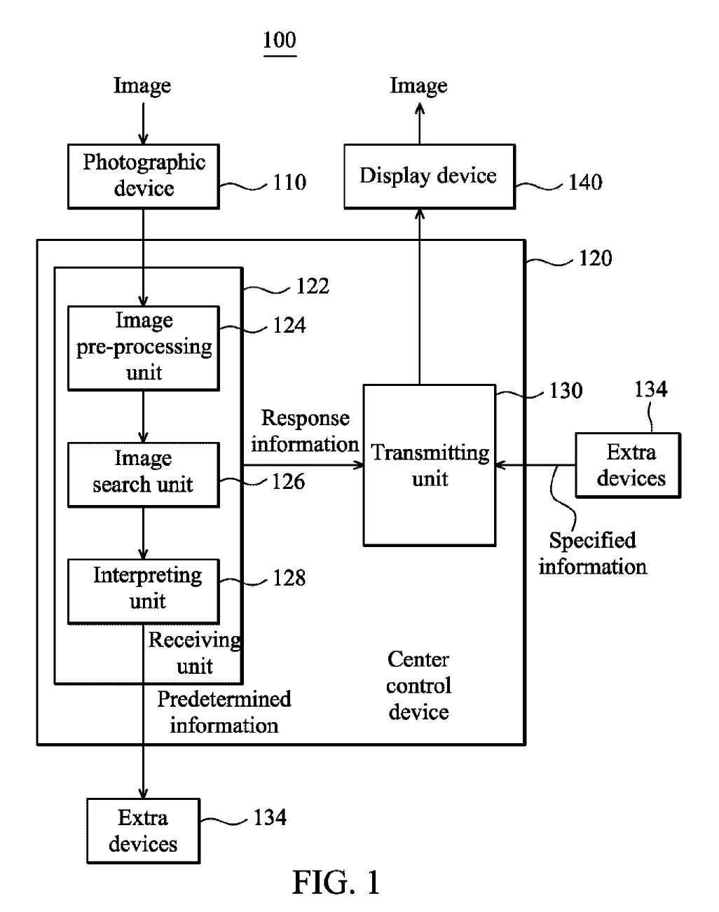

FIG. 1 is a diagram showing a visual-based contactless communication device of the invention. The visual-based contactless communication device 100 includes a photographic device 110, a center control device 120 and a display device 140.

The photographic device 110 such as a camera is mainly used to photograph image data displayed from other visual-based contactless communication devices. The center control device 120 is used to identify the image data photographed by the photographic device 110, and transform certain information into effective image data. The center control device 120 may generate response information according to predetermined information contained in the image data and then transform the response information into effective image data, or generate specified information by itself and then transform the specified information into the effective image data, or receive specified information from extra devices 134 and then transform the specified information into effective image data. In one embodiment, the predetermined information, specified information and response information are a kind of communication message having substantially expressible meaning. The image data or the effective image data may be symbols, letters, pictures, articles, or barcodes, or any other meaningful images or codes, or combinations thereof only as the data is recognizable by visual-based contactless communication devices. Hence, users can devise various types of image data in the application.

The center control device 120 further includes receiving unit 122 and transmitting unit 130. The receiving unit 122 is used to receive image data from the photographic device 110, detect whether the image data include the predetermined information and send the predetermined information to extra devices 134. The transmitting unit 130 is used to receive specified information from extra devices 134 or generate specified information by itself and transform the response information or the specified information into the effective image.

In one embodiment, the receiving unit 122 further includes an image pre-processing unit 124, an image search unit 126 and an interpreting unit 128. The image pre-processing unit 124 is used to perform luminance adjustment, noise elimination, color graying and binarization to the photographed image data. In another embodiment, the image pre-processing unit 124 may selectively employ an image processing technique; for example, if necessary only luminance adjustment or noise elimination is performed to the image data. The image search unit 126 is used to find a distribution range of the predetermined information in the image data. Generally, pictures or symbols which contain the predetermined information only occupy a small portion of the image data. Therefore, the image search unit 126 will find the range or location of the predetermined information according to a predetermined characteristic such as specific color area, covered area by a frame, or covered area by an appearance shape defined by users. The interpreting unit 128 is used to interpret the predetermined information within the range defined by the predetermined characteristic. The interpreting method is variable according to different image types. For example, when the image data is a letter/number, an optical character recognition (OCR) is used. When the image data is a barcode, a barcode engine is used. When the image data is a user-defined color/gray image, an image comparison device is used. In another embodiment, when the image type changes, the function of the receiving unit 122 may also change. For example, a new unit for further processing the image data may be added into the receiving unit 122, or a unit such as an image pre-processing unit 124 may be not used. The above-mentioned embodiment is for illustrative purposes and not limiting.

The display device 140 such as an LCD etc. is used to display the effective image data that contains the specified information or the response information. For other visual-based contactless communication device, the effective image data is viewed as the image data that contains the predetermined information.

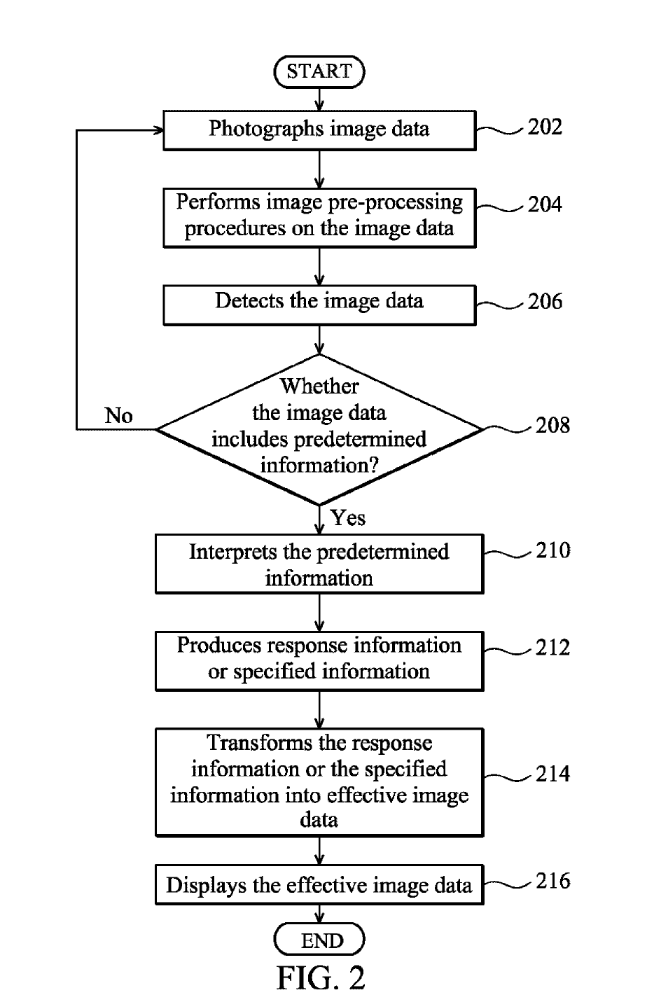

FIG. 2 is a flow chart illustrating a visual-based contactless communication method according to the embodiment of the invention. In the embodiment, the image data is standard two-dimensional barcode, or QR code. In step 202, the visual-based contactless communication device photographs a QR code displayed by another visual-based contactless communication device. In step 204, image pre-processing procedures such as luminance adjustment, noise elimination, color graying and binarization are performed to the QR code. In step 206, the QR code is identified. The QR code may be identified by, for example, determining a location or range of the QR code, and it is determined whether the QR code contains the predetermined information. The QR code may be located within a range or location of a predetermined characteristic such as a specific color area, a frame, or a user-defined appearance shape. The predetermined information can be set according to users. For example, specific numbers may represent specific communication meanings, or one symbol may represent a specific communication meaning etc. In the embodiment, if the QR code does not contain predetermined information, step 202 is performed. Step 202 is performed if the QR code contains the predetermined information, wherein the predetermined information is interpreted in step 210. A variety of interpretation methods may be employed according different image data types. In step 212, response information is produced according to the predetermined information, or specified information is received from extra devices. In step 214 and 216, the response information or the specified information is transformed into effective image data in QR code type recognizable by other visual-based contactless communication devices, and the image data is displayed in a display. The above-mentioned embodiment is for illustrative purposes and not limited thereto.

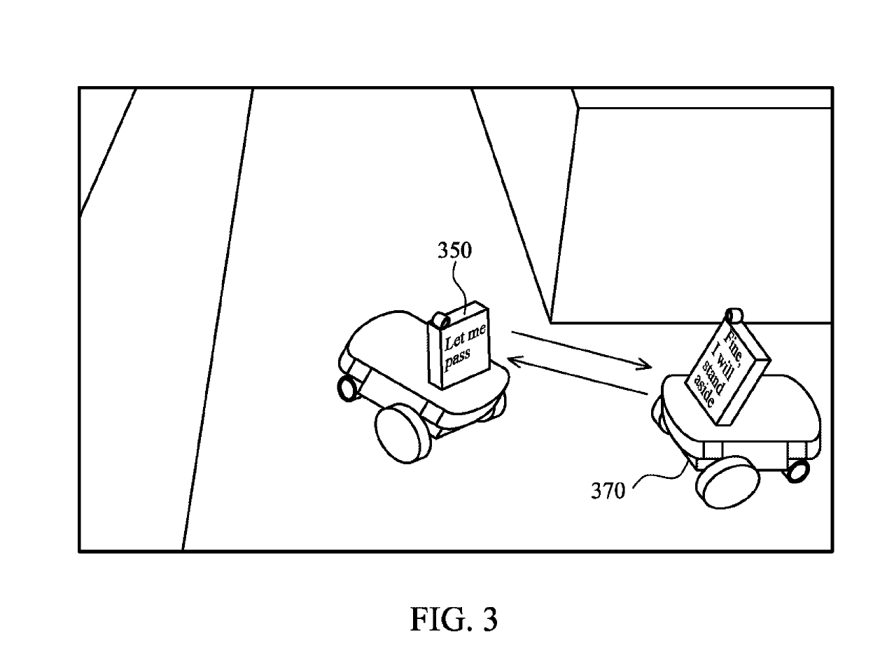

FIG. 3 is a diagram showing a bi-directional communication embodiment of visual-based contactless communication devices of the invention. First, two visual-based contactless communication devices, a first device 350 and a second device 370, is provided. Based on a bi-directional communication mechanism, after the first device 350 delivers a message “let me pass” to the second device 370, the second device 370 will generate a response message such as “Fine, I will stand aside” to the first device. Only after the first device 350 confirms that the response message “Fine, I will stand aside” has been received and recognized, will the first device 350 be allowed to proceed with subsequently communication procedures.

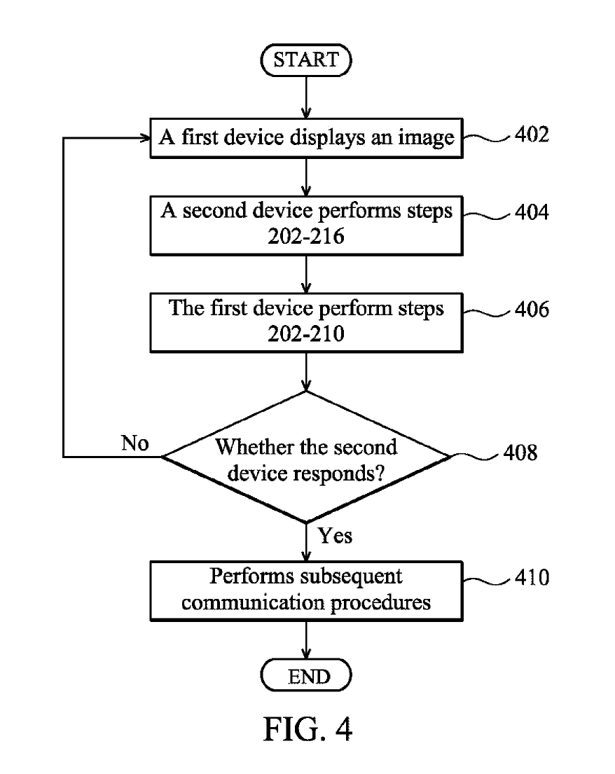

FIG. 4 is a flow chart illustrating bi-directional communication according to the embodiment of FIG. 3 of the invention. In step 402, the first device 350 displays image data “let me pass” in its display as FIG. 3 shows. In step 404, the second device 370 performs step 202 to 216 as FIG. 2 shows to identify the image data and interpret the meaning of the message “let me pass”. Then the second device 370 produces effective image data containing message “Fine, I will stand aside”. In step 406-408, the first device 350 performs steps 202-210 as FIG. 2 shows to determine whether the response information “Fine, I will stand aside” has been interpreted. If the response information has not been received then the first device 350 will continuously display the image data “let me pass” until the first device 350 confirms that a response message from the second device is received and recognized (the response information may be a message “I am busy”, for example). Only after confirming that the response message has been received and recognized, will the first device 350 is allowed to undertake other subsequent communication procedures such as, for example, to communicating with another visual-based devices. Contrarily, after receiving the message “I am busy” from the second device 370, the first device 350 will have to query the second device 370 about the busy situation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A visual-based contactless communication device adapted to communicate with one or more visual-based contactless devices, comprising:
a photographic device for photographing image data displayed by one or more visual-based contactless communication devices;
a center control device for identifying predetermined information in the image data, producing response information according to the predetermined information and generating effective image data identifiable by one or more visual-based contactless communication devices according to the response information or specified information; and
a display device for displaying the effective image data to be photographed by one or more visual-based contactless communication devices;
wherein when two visual-based contactless communication devices communicate with each other, one displays the effective image data with the response information after identifying the predetermined information, and the other proceeds with subsequent communication only after identifying the effective image with the response information and confirming that the response information is recognized.

2. The device as claimed in claim 1, wherein the center control device further comprises:
a receiving unit for receiving the image data from the photographic device, detecting whether the image data contains the predetermined information and sending the predetermined information to extra devices; and
a transmitting unit for receiving the specified information from extra devices or producing the specified information, transforming the specified information or the response information to the effective image data and transmitting the effective image data to the display device.

3. The device as claimed in claim 2, wherein the receiving unit further comprises an image pre-processed unit for selectively performing luminance adjustment, noise elimination, color graying and binarization to the image data.

4. The device as claimed in claim 2, wherein the receiving unit further comprises an image search unit for finding a distribution range of the predetermined information according to a predetermined characteristic of the image data.

5. The device as claimed in claim 4, wherein the receiving unit further comprises an interpretive unit for interpreting the predetermined information.

6. The device as claimed in claim 5, wherein the predetermined characteristic comprises a specific color, a frame, or appearance shape defined by users of the image data.

7. The device as claimed in claim 5, wherein the image data comprises symbols, letters, pictures, articles, or barcodes or any other meaningful images, codes or the likes or combinations thereof.

8. A visual-based contactless communication method adapted to communicate with one or more visual-based contactless devices, comprising:
photographing image data displayed by one or more visual-based contactless communication devices by a photographic device in a visual-based contactless communication device;
identifying predetermined information in the image data, producing response information according to the predetermined information and generating effective image data identifiable by one or more visual-based contactless communication devices according to the response information or specified information by a center control device in the visual-based contactless communication device; and
displaying the effective image data to be photographed by one or more visual-based contactless communication devices by a display device in the visual-based contactless communication device;
wherein when two visual-based contactless communication devices communicate with each other, one displays the effective image data with the response information after identifying the predetermined information, the other proceeds with subsequent communication only after identifying the effective image data with the response information and confirming that the response information is recognized.

9. The method as claimed in claim 8, wherein identifying the predetermined information in the image data further comprises:
detecting whether the image data contains the predetermined information; and
interpreting the predetermined information.

10. The method as claimed in claim 9, wherein detecting the image comprises:
finding a distribution range of the predetermined information according to a predetermined characteristic of the image data.

11. The method as claimed in claim 8, further comprising:
selectively performing luminance adjustment, noise elimination, color graying and binarization to the image data.
